(19) United States
(12) Patent Application Publication
(10) Pub. No.: US 2009/0307749 A1
(43) Pub. Date: Dec. 10, 2009

(54) APPARATUS AND METHOD FOR INTELLECTUAL PROPERTY MANAGEMENT AND PROTECTION

(76) Inventors: Ho-Jae Lee, Daejon (KR); Gun Bang, Daejon (KR); Hyon-Gon Choo, Daejon (KR); Je-Ho Nam, Seoul (KR); Jin-Woo Hong, Daejon (KR)

Correspondence Address: LADAS & PARRY LLP, 224 SOUTH MICHIGAN AVENUE, SUITE 1600, CHICAGO, IL, 60604, US

(21) Appl. No.: 12/373,552

(22) PCT Filed: Jul. 12, 2007
(86) PCT No.: PCT/KR2007/003388

§ 371 Date: Jan. 13, 2009

(30) Foreign Application Priority Data
Jul. 14, 2006 (KR) 10-2006-0066475

(51) Int. Cl. G06F 21/00; G06F 15/16

(52) U.S. Cl. 726/3; 709/204

(57) ABSTRACT

Provided is an apparatus and method for intellectual property management and protection (IPMP). The present research provides an interface for confirming IPMP tools and exchanging information and an interface for managing a domain. The IPMP apparatus using a tool for managing and protecting intellectual property of contents and the other tool interacting with the first tool, includes: a tool information extraction unit for detecting information of the second tool based on a request of the first tool; and a tool reference unit for detecting a location of’ the second tool based on a request of the first tool and the extracted information of the second tool. The present research is applied to an IPMP apparatus.

### TECHNICAL FIELD

The present invention relates to an apparatus and method for intellectual property management and protection (IPMP); and, more particularly, to an apparatus and method for intellectual property management and protection (IPMP), which provide interoperability among IPMP tools and an interface for managing a domain.

The domain means a set of devices that share the same properties of a personal or a group such as an ownership, and the tool is a means for managing and protecting digital contents from illegal use such as encryption, authentication, and watermarking.

This work was partly supported by the Information Technology (IT) research and development program of the Korean Ministry of Information and Communication (MIC) and/or the Korean Institute for Information Technology Advancement (IITA) [2005-S-403-02, “Development of Super-intelligent Multimedia Anytime-anywhere Realistic TV (SmarTV) Technology.”

### BACKGROUND ART

Due to the rapid progress of Internet environment and the introduction of high-speed and wideband network environment, it was popularized to download and upload multimedia contents through network environment, and there have been many studies in progress for developing digital right management (DRM) technologies to protect the multimedia contents from illegal copy and unauthorized use. The studies for the DRM technologies have been progressed to satisfy not only customers but also composers and distributors within the life cycle of the digital contents through digital water marking and encoding within a life cycle of the contents.

One of the DRM technologies is an intellectual property management and protection (IPMP). The IPMP manages and protects the right for a digital item (DI) based on a MPEG standard.

MPEG-21 IPMP is a standard for IPMP information to safely handle digital items in generation, adaptation, transmission, and consumption on the network. That is, the IPMP defines an information system that describes the basic information of IPMP for providing the interoperability among various DRM technologies.

Basic functional unit modules used in a typical DRM technology are defined as IPMP tools in MPEG standard. That is, each of the DRM technologies such as authentication, encryption, and water marking, is defined as an individual tool, and a terminal is allowed to use such various protection tools.

That is, a tool used in an entire DRM system is modulized into a plurality of tool modules. The modulization makes it possible to include or to exclude predetermined tool modules according to the necessity thereof. In order to include or exclude predetermined modules of the tool, tool IDs are required to identify each of the IPMP tools.

In order to use such IPMP tools in the MPEG standard, it is required to allocate tool IDs at first. A terminal uses the tool ID to confirm IPMP tools applied to protected contents and uses the necessary IPMP tools.

An IPMP interface consists of a trust management interface and a tool interface. The trust management interface is a set of interfaces to support a tool that accesses protected information and is a means for accessing to access protected or managed information such as a key or a signature through a certification or a license. The tool interface is a set of interfaces to perform various IPMP functions based on IPMP information and process contents protected using the IPMP tools from illegal use.

Herein, it is required to define an application program interface (API) for processing tools that handle the ID and related information required to identify various tools.

Related to the trust management interface and the tool management interface, following conditions are required. 1) MPEG-21 IPMP needs to support the authentication between users, peers, and domains (user/peer/managed domain authentication), 2) the interoperability must be supported between peers (the interoperability of peers), and 3) it is required to support non-IPMP peers that interact with digital items (comparability of non-IPMP peers).

Related to these conditions, an IPMP interface is demanded to provide the interoperability between tools by providing a search and access supporting interface using IPMP information between IPMP tools or peers.

In order to search IPMP tools or the reference of a tool group, a new IPMP interfaces is required in the tool interface. Herein, the reference denotes pointer information to connect with other tools.

That is, it requires an interface for exchanging information for confirming an IPMP tool between an IPMP terminal and a tool.

For example, if a predetermined IPMP tool needs the assistance of another IPMP tool while the predetermined IPMP tool is in operation, the predetermined IPMP tool searches a desired IPMP tool and interacts with the searched IPMP tool. In order to search the desired IPMP tool, the predetermined IPMP tool communicates with an IPMP terminal at first. Then, the predetermined IPMP tool communicates with the searched IPMP tool, thereby interacting with the searched IPMP tool.

Meanwhile, a new interface is required to manage a domain for trust management interface. The domain denotes a set of devices that share the same properties such as the ownership of a personal and a group. The object of managing the domain is to allow any devices in the same device group that share the same properties, such as home, to use the same contents.

### DISCLOSURE

### Technical Problem

An embodiment of the present invention is directed to providing an intellectual property management and protection (IPMP) interface for interoperability between tools by providing a search and access support interface using IPMP information between IPMP tools or peers.

Another embodiment of the present invention is directed to providing an interface for managing a domain in order to allow a predetermined group forming a domain to share protected contents.

### Technical Solution

In accordance with an aspect of the present invention, there is provided an apparatus and method for intellectual property management and protection, which can exchange information by confirming IPMP tools and manage a domain.

### ADVANTAGEOUS EFFECTS

An apparatus and method for intellectual property management and protection (IPMP) according to an embodiment of the present invention enable IPMP tools to exchange information by confirming IPMP tools and manage a domain. Therefore, tools are enables to interoperate with each other, and a predetermined domain is allowed to use protected contents.

### BRIEF DESCRIPTION OF THE DRAWINGS

FIG. 1 is a block diagram illustrating a general digital broadcasting receiving apparatus.

FIG. 2 is a block diagram depicting a general digital broadcasting receiving apparatus for intellectual property management and protection (IPMP).

FIG. 3 is a block diagram showing a digital broadcasting receiving apparatus in accordance with an embodiment of the present invention.

FIG. 4 is a block diagram illustrating an IPMP interface in accordance with an embodiment of the present invention.

FIG. 5 is a flowchart of a method for driving a digital broadcasting receiving apparatus with an IPMP interface in accordance with an embodiment of the present invention.

FIG. 6 is a flowchart illustrating a method for managing a domain in accordance with an embodiment of the present invention.

### BEST MODE FOR THE INVENTION

To achieve the objects of the present invention, in accordance with an aspect of the present invention, there is provided an intellectual property management and protection (IPMP) apparatus using a tool (first tool) for managing and protecting intellectual property of contents and the other tool (second tool) interacting with the first tool, including: a tool information extraction unit for extracting information of the second tool based on a request of the first tool; and a tool reference unit for retrieving a location of the second tool based on the request of the first tool and the extracted information of the second tool.

In accordance with another aspect of the present invention, there is provided an intellectual property management and protection (IPMP) method using a first tool for managing and protecting intellectual property for contents and a second tool interacting with the first tool, including the steps of: a) extraction information of the second tool based on a request of the first tool; and b) retrieving a location of the second tool based on the request of the first tool and the extracted information of the second tool.

In accordance with another aspect of the present invention, there is provided an intellectual property management and protection (IPMP) apparatus including: an initiator for transmitting a domain management request including authentication information; an authentication unit for performing an authentication process based on the authentication information transferred from the initiator; and a domain manager for responding the domain management request based on the authentication result from the authentication unit, wherein the domain is a set of devices that share same properties.

In accordance with another aspect of the present invention, there is provided an intellectual property management and protection (IPMP) method including the steps of: a) transmitting a domain management request including authentication information; b) performing an authentication process based on the authentication information transmitted at the step a); c) managing a domain by responding the domain management request based on the authentication result, wherein the domain is a set of devices sharing same properties.

The advantages, features and aspects of the invention will become apparent from the following description of the embodiments with reference to the accompanying drawings, which is set forth hereinafter.

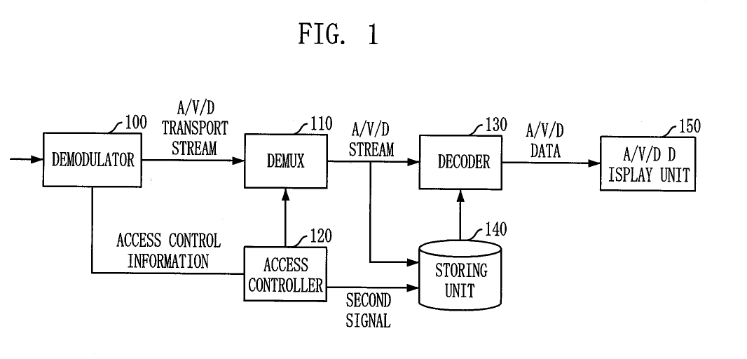

FIG. 1 is a block diagram illustrating a general digital broadcasting receiving apparatus. That is, FIG. 1 shows a terminal whether the present invention may be applied to.

Referring to FIG. 1, a demodulator 100 receives broadcasting signal, provides audio/video/data transport stream to a DEMUX 110 and provides access control information for multiplexed audio/video/data transport stream to an access controller 120.

The DEMUX 110 separates the multiplexed audio/video/data transport stream into element streams and provides the element streams to a decoder 130 and a storing unit 140.

The access controller 120 generates a first control signal based on access control information and generates a second control signal for storing the element stream. The access controller 120 provides the first control information to the DEMUX 110 and the second control information to the storing unit 140.

The decoder 130 decodes the element streams provided from the storing unit 140 or the DEMUX unit 110, and provides the decoding result, audio/video/data, to an A/V/D display unit 150.

The A/V/D display unit 150 displays the provided audio/video/data to a user.

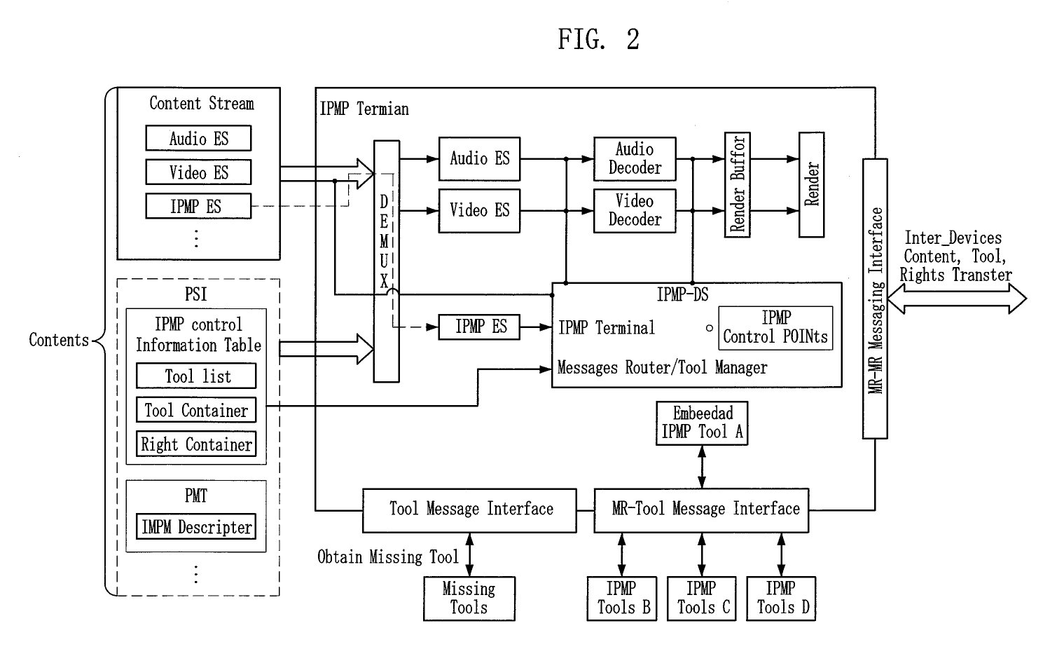

FIG. 2 is a block diagram depicting a digital broadcasting receiving apparatus for intellectual property management and protection (IPMP). That is, FIG. 2 shows a terminal where the present invention may be applied to.

In FIG. 2, blocks connected to an IPMP terminal indicate blocks where a consumption policy can be applied before a user consumes contents. That is, each of the blocks is a point for an IPMP terminal to access multiplexed MPEG transport stream, video/audio stream, and video/audio data.

For example, in case of a MPEG transport stream, a consumption policy may be assigned in the header information of a transport stream. In case of video/audio stream, a policy for decoding each of coded streams can be applied. In case of decoded video/audio data, an IPMP terminal may apply a policy that can sense deformation or duplication through signature information or watermark information included in the video/audio data.

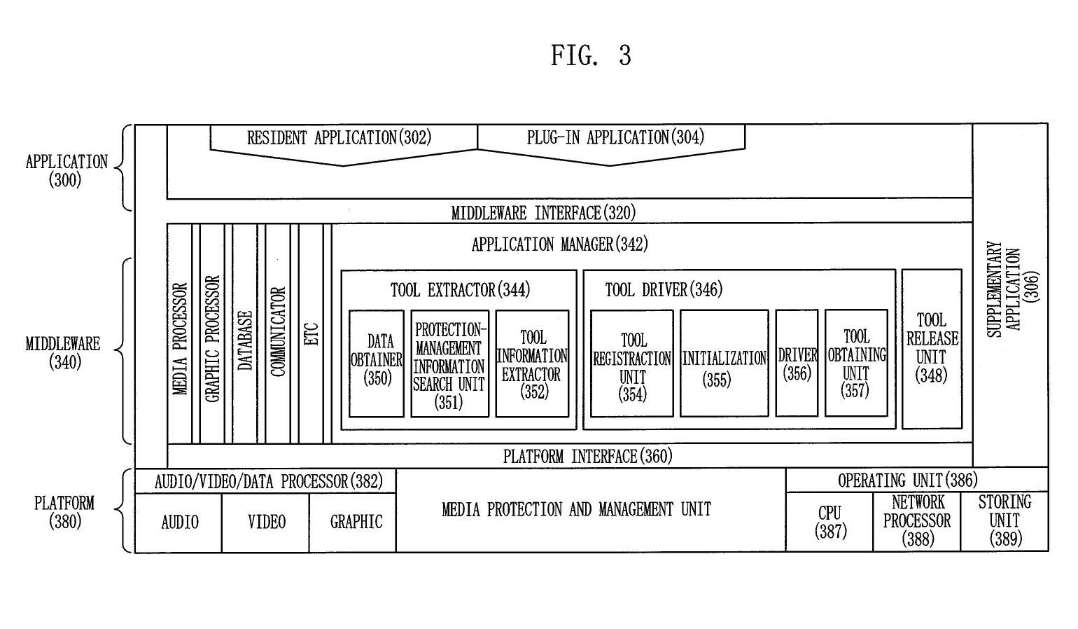

FIG. 3 is a block diagram showing a digital broadcasting receiving apparatus in accordance with an embodiment of the present invention. That is, FIG. 3 shows a terminal where the present invention is applied to.

As shown in FIG. 3, the digital broadcasting receiving apparatus according to the present embodiment includes an application 300, a middleware interface 320, a middleware 340, a platform interface 360, and a platform 380.

The digital broadcasting receiving apparatus according to the present embodiment includes an application manager 342 for controlling a policy for managing and protecting application and controls through a middleware API layer.

A platform 380 includes an audio/video/data processor 382, a media protection and management unit 384, and an operating unit 386. The platform 380 stores data in a predetermined unit, for example, a storing unit 389. However, the present invention is not limited thereto. For convenience, a device providing data is referred as an initiator throughout the specification.

The audio/video/data processor 382 includes an audio decoding function, a video decoding function, and a graphic processing function, for example, which are embodied as hardware.

The operating unit 386 generally controls the digital broadcasting receiving apparatus with a central processing unit 387, a network processor 388, and a storing unit 389.

The media protection and management unit 384 protects and manages contents among data storing in the platform 380.

The application 300 includes resident application 302, a plug-in application 304, and supplementary application 306. The IPMP terminal may be the resident application 302, and the protection tools may be the resident application 302 or the plug-in application 304. Also, the IPMP terminal receives the support of a middleware 340 through the middleware API. Therefore, the IPMP terminal performs a function of protecting and managing contents based on the support of the middleware 340.

The middleware 340 is included for comparability between various platforms and applications. The middleware 340 supports the operation of each application through the middleware interface 320. The middleware interface 320 interfaces the resident application 302, the plug-in application 304, and the middleware 340 as a form of a middleware API.

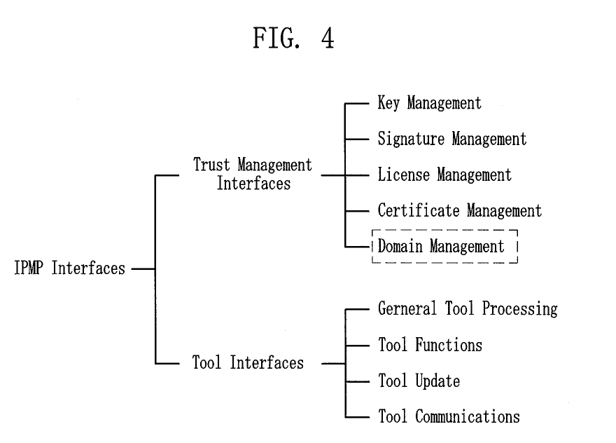

The IPMP interface according to the present embodiment may include the middleware interface 320. FIG. 4 is a block diagram illustrating an IPMP interface in accordance with an embodiment of the present invention

As shown in FIG. 4, the IPMP interface according to the present embodiment includes trust management interfaces and tool interfaces. The IPMP interface according to the present embodiment confirms an IPMP tool and an IPMP tool group and exchanges necessary information between an IPMP terminal and a tool. The IPMP interface includes identifiers for identifying each tool and obtaining necessary information.

The trust management interface includes key management, signature management, license management, certification management, and domain management.

The tool interface includes general tool processing, tool function, tool update and tool communication.

Referring to FIG. 3 again, the middleware 340 includes an application manager 342 for supporting the consumption of contents.

The application manager 342 includes a tool extractor 344, a tool driver 346, and a tool release unit 348.

The tool extractor 344 extracts tool information related for protecting and managing contents. The tool extractor 344 includes a data obtainer 350, a protection and management information search unit 341, and a tool information extractor 352.

The data obtainer 350 receives data from the platform 380 through the platform interface 360.

The protection and management information search unit 341 searches protection and management information related to the protection and management of contents.

The tool information search unit 352 extracts tool information related to the protection and management of contents, tool context information, and reference information of an IPMP tool.

The tool driver 346 drives a protection and management tool corresponding to the detected tool information. The tool driver includes a tool registration unit 354, an initialization unit 355, a driver 356, and a tool obtaining unit 357.

The tool registration unit 354 confirms whether a protection and management tool corresponding to the detected tool information is registered or not.

If the protection and management tool corresponding to the detected tool information is not registered, the tool obtaining unit 355 obtains the protection and management tool through the platform 380, installs and registers the obtained protection and management tool.

The initialization unit 356 initializes the protection and management tool corresponding to the extracted tool information.

The driver 357 drives the initialized protection and management tool.

The tool release unit 348 receives the termination information of the protection and management tool and releases the protection and management tool from a driving tool list.

Meanwhile, the protection and management tool may be embodied as a form of the resident application 302 or the plug-in application 304, and is executed by the driver 346.

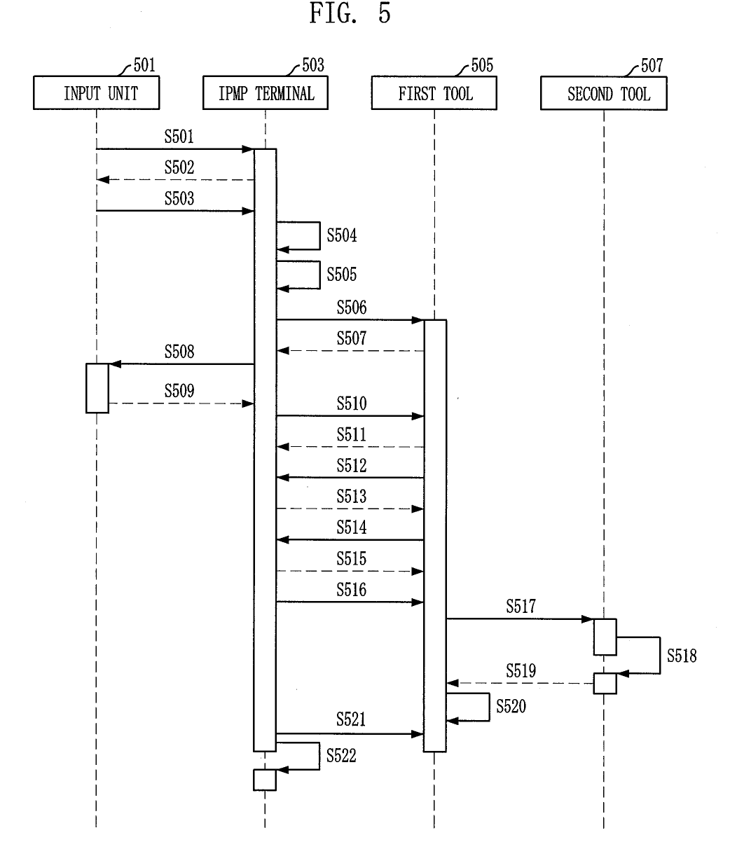

FIG. 5 is a flowchart of a method for driving a digital broadcasting receiving apparatus with an IPMP interface in accordance with an embodiment of the present invention. The flowchart of FIG. 5 shows how the application manager 342 of FIG. 3 is driven through a middleware API layer. The middleware API of the application manager 342 defines the interface among an initiator 501, an IPMP terminal 503, and protection and management tools 505 and 507. The protection and management tools 505 and 507 operate along the consumption policy of contents through the defined interface.

As shown in FIG. 5, the initiator 501 initializes the IPMP terminal 503 at step S501 (Invoke), and the IPMP terminal 503 responses for the initialization at step S502.

Then, the initiator 501 transfers the protection processed information, for example, contents, to the IPMP terminal 503 at step S503 (getStreamData). That is, the IPMP terminal 503 controls the data obtaining unit 350 to receive data from the initiator 501 through the platform interface 360.

Then, the IPMP terminal 503 controls the tool information extractor 352 to retrieve the IPMP tool information related to the protection and management of contents at step S504 (retrieveIPMPInfor).

Then, the IPMP terminal 503 controls the protection and management information search unit 351 to search protection and management information related to the protection and management of contents at step S505 (parseIPMPInfo).

Then, the IPMP terminal 503 controls the tool registration unit 354 to confirm whether a protection and management tool corresponding to the detected IPMP tool information is registered or not at steps S506 and S507 (getTools, return).

If the tool corresponding to the detected IPMP tool information is not registered, the tool obtainer 357 obtains a protection and management tool corresponding to the detected IPMP tool information through the platform 380, installs and registers the obtained tool at steps S508 and S509 (retrieveMissingTool, return).

Meanwhile, if it is determined that the tool corresponding to the extracted IPMP tool information such as a first tool 505 is registered, the IPMP terminal 503 controls the initialization unit 355 to initialize the protection and management tool such as the first tool 505 at steps S510 and S511 (initTools, return).

Hereinafter, when the first tool 505 interacts with the other tool such as a second tool 507, related processes for driving a digital broadcasting receiving apparatus with an IPMP interface in accordance with an embodiment of the present invention will be described.

The first tool 505 requests the IPMP terminal 503 to determine whether the second tool 507 is in the IPMP terminal 503 or not at step S512 (getToolContext). The IPMP terminal 503 controls the tool information extraction unit 352 to extract the information about the second tool 507 at step S513 (return). That is, the IPMP terminal 503 determines the existence of the second tool 507 by parsing information about the second tool 507 from the tool contexts. The tool context is an IPMP information list including information about tool IDs, substitutable tools, and tool locations.

The first tool 505 may provide the tool ID of the second tool 507 to the IPMP terminal 503. Herein, the first tool 505 confirms the necessity of the second tool 507 and obtains the tool ID of the second tool 507 based on the tool information detected at the step S504 or reference included in the first tool 505.

The first tool 505 requests the IPMP terminal 503 to search the reference of an IPMP tool group related to the second tool 507 or the reference of a predetermined single IPMP tool not included in the related IPMP tool group at steps S514 (getToolReference or getToolGroupReference).

The IPMP terminal 503 controls the tool information extractor 352 to retrieve an IPMP tool or the reference of a tool group at step S515 (return). The first tool 505 can confirm the location of the second tool 507 for physical access through the steps S514 and S515. The reference denotes pointer information that can be connected to the other tool or tool group.

The IPMP terminal 503 controls the driver 357 to drive the initialized first tool 505 at step S516 (operateTool). The application manager 342 includes the currently driving first tool 505 into a driving tool list.

The first tool 505 controls the driver 357 to drive the second tool 507 at step S517 (operateTool). The application manager 432 includes the currently driving second tool 507 in a driving tool list.

The second tool 507 performs corresponding operations with the support of the application manager 342 at step S518 (ToolProcessing). Then, the second tool 507 reports the result thereof to the first tool 505 at step S519 (return).

Then, the first tool 505 performs corresponding operation with the support of the application manager 342 at step S520 (ToolProcessing).

Then, the IPMP terminal 503 requests the first tool 505 to terminate the related operation at step S521 (TerminateTool). The tool release unit 348 receives the termination information of the driven protection and management tools 505 and 507 and releases the driven protection and management tools 505 and 507 from the driving tool list at step S522 (revokeTool).

The interface used in the above described processes is embodied as follows.

Interface MmIIPMPToolIdentifier {
UUID getToolContext(in IPMPDescriptor ipmpInfo);
UUID getToolGroupReference(in UUID toolID);
UUID getToolReference(in UUID toolID);
}

Herein, the MmIIPMPToolIdentifier is an IPMP interface for identifying a tool processed by the IPMP terminal 503, and the UUID is a universal unique identifier.

Table 1 shows the definitions and the functions of parameters in the interface.

IPMPDescriptor ipmpInfo is the information of IPMPDescriptor. IPMPDescriptor denotes a tool context defined in MPEG-2/4 Intellectual Property Management and Protection Extension (IPMPX). Also, UUID toolID denotes a tool ID having a UUID.

TABLE 1
getToolContext

| | |
|---|---|
| Parameter | IPMPDescriptor ipmpInfo |
| description | search predetermined tool context ID |

getToolGroupReference

| | |
|---|---|
| Parameter | UUID toolID |
| description | Search reference of IPMP tool group related |
| | to corresponding inputted toolID |

getToolReference

| | |
|---|---|
| Parameter | UUID toolID |
| description | search reference of a predetermined single |
| | IPMP tool not included in IPMP tool group |
| | according to inputted toolID |

For example, the getToolContext is an IPMP interface between the first tool 505 and the IPMP terminal 503 for determining whether the second tool 507 is present or not based on the reference of the first tool 505 and the tool ID of the second tool 507, which is obtained from the tool information extracted at the step S504. The getToolGroupReference and getToolReference are IPMP interfaces between the first tool 505 and the IPMP terminal 503 for the first tool 505 to confirm the location of the second tool 507.

A domain management interface according to an embodiment to the present invention is an IPMP interface for managing domain elements such as domain information and apparatus information. The domain denotes a set of apparatuses sharing the same properties such as the ownership of a personal or a group. The object of managing the domain is to allow any apparatus in the corresponding apparatus group that sharing the same properties to use the same contents.

The domain management is performed through following five interfaces for adding a new domain, deleting a domain, updating a domain, registering a device, and releasing a device. The five interfaces are defined as follows.

Interface MmIDomainManager
{
Bool requestNewDomain(in DomainInfo domainInfo);
Bool requestRevokeDomain (in DomainInfo

domainInfo);

Bool requestAuthenticate(in DomainInfo domainInfo)
Bool requestupdateDomain(in DomainInfo domainInfo,

in DomainInfo newDomainInfo);

Bool createDomainInfo(in DomainInfo domainInfo);
Bool deleteDomainInfo(in DomainInfo domainInfo);
Bool createDeviceInfo(in DomainInfo domainInfo);
Bool deleteDeviceInfo(in DomainInfo domainInfo);
Bool requestSubscribeDevice(in DomainInfo

domainInfo);

Bool requestUnsubscribeDevice(in DomainInfo

domainInfo);

Bool verifyDomainInfo(in DomainInfo domainInfo)
Bool updateDomain(in DomainInfo domainInfo);
}

The verifyDomainInfo is an interface for determining whether a domain is valid or not.

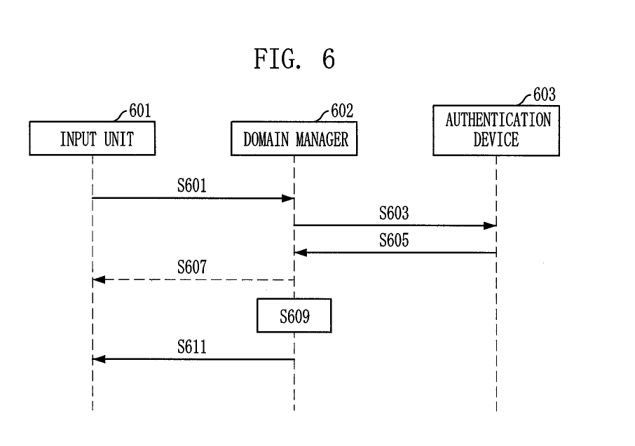

Hereinafter, the five interfaces for adding a new domain, deleting a domain, updating a domain, registering a device, and releasing a device will be described with reference to FIG. 6.

FIG. 6 is a flowchart of a method for managing a domain in accordance with an embodiment of the present invention.

Among the interfaces for managing a domain, a domain addition process starts by a request from an initiator 601 to a domain manager 603 in order to add a new domain at step S601 (requestNewDomain). The request includes authentication information for authenticating a user or a device.

Then, the domain manager 603 transfers the information inputted from the initiator 601 to the authenticator at step S603.

The authenticator 605 performs the authentication process based on the information received from the domain manager 603.

If the authentication fails, the domain manager 603 transfers the error message to the initiator 601 at steps S605 and S607 (ERR Message).

Meanwhile, if the information received from the domain manager 603 successfully passes the user authentication at step S605 (return Message), the domain manager 603 generates a new domain at step S609 (createDomainInfo), and transfers the result of the domain generation to the initiator 601 at step S611 (return message).

Table 2 shows the definitions and functions of parameters in the domain adding process. DomainInfo domainInfo, used as a parameter, denotes domain related information such as a domain key, domain name, user information and an Internet protocol (IP) address of a predetermined user for using the protection processed contents.

TABLE 2
requestNewDomain

| | |
|---|---|
| Parameter | DomainInfo domainInfo |
| description | Request for adding new domain |

request Authenticate

| | |
|---|---|
| Parameter | DomainInfo domainInfo |
| description | Confirm input information such as |
| | manager information. If the |
| | information is valid, transmit true. |
| | If not, transmit false. |

requestNewDomain

| | |
|---|---|
| Parameter | DomainInfo domainInfo |
| description | Add new domain. If no error occurs, |
| | transmit true. If error occurs, |
| | transmit false. |

The requestNewDomain is an interface for managing a domain between the initiator 601 and the domain manager 603 for adding a new domain. The requestAuthenticate is an interface for managing a domain between the domain manager 603 and the authentication device 605. If the authenticator 605 makes a successful authentication, the authenticator 605 transmits a true value to the domain manager 604. If not, the authenticator 605 transmits a false value. The createDomainInfor is an interface for the domain manager 603 to add information. The domain manager 603 transmits a true value to the initiator 601 if no error occurs in the domain adding process. If error occurs, the domain manager 603 transmits a false value.

In a domain deleting process, since the interface of the step S601 is substituted from requestNewDomain to requestRevokeDomain, the initiator 601 requests the domain manager 603 to delete a predetermined domain. Also, the domain manager 603 deletes the requested predetermined domain by substituting the interface of the step S609 from createDomainInfo to deleteDomainInfo. The result of the deleting the predetermined domain is transferred to the initiator 601 at step S611 (return Message).

Table 3 shows the definitions and functions of parameters in the domain deleting process.

TABLE 3
requestRevokeDomain

| | |
|---|---|
| Parameter | DomainInfo domainInfo |
| description | Request for deleting a predetermined |
| | domain |

deleteDomainInfo

| | |
|---|---|
| Parameter | DomainInfo domainInfo |
| description | Delete requested domain. If no error |
| | occurs, transmit true. If error occurs, |
| | transmit false. |

The requestRevokeDomain is an interface for managing a domain between the initiator 601 and the domain manager 603 for deleting a domain. The deleteDomainInfo is an interface for the domain manager 603 to delete a predetermined domain. If no error occurs, the domain manager 603 transmits a true value to the initiator 601. If error occurs, the domain manager 603 transmits a true value to the initiator 601. If no error occurs, the domain manager 603 transmits a false value to the initiator 601.

In a domain update process, the initiator 603 requests the domain manager 603 to update the information of a predetermined domain by substituting the interface of the step S601 from requestNewDomain to requestupdateDomain. The domain manager 603 updates the information of the requested predetermined domain by substituting the interface of the step S609 from createDomainInfo to updateDomain. The result of updating the information of the predetermined domain is transferred to the initiator 601 at step S611 (return Message).

Table 4 shows the definitions and functions of parameters in the domain update process.

DomainInfor newDomaiInfor, used as a parameter, denotes a key value of a predetermined user or an IP address for an updated domain to use protection processed contents.

TABLE 4
requestupdateDomain

| | |
|---|---|
| Parameter | DomainInfo domainInfo |
| | DomainInfo newDomainInfo |
| description | Request for updating a predetermined domain |

updateDomain

| | |
|---|---|
| Parameter | DomainInfo domainInfo |
| description | Update predetermined domain information. If |
| | no error occurs, transmit true. If error |
| | occurs, transmit false. |

The requestupdateDomain is an interface for managing a domain between the initiator 601 and the domain manager 603 for updating the information of a predetermined domain. The updateDomain is an interface for the domain manager 603 to update the information of a predetermined domain. If no error occurs in the domain information update process, the domain manager 603 transmits a true value to the initiator 601. If error occurs, the domain manager 603 transmits a false value to the initiator 601.

In a process for registering a device in a domain, the initiator 601 requests the domain manager 603 to register devices to a domain by substituting the interface of the step S601 from requestNewDomain to requestSubscribeDevice. The domain manager 603 registers the device in a domain according to the request by substituting the interface of the step S609 from createDomainInfo to createDeviceInfor. The result of registering the device is transferred to the initiator 601 at step S611 (return Message).

Table 5 shows the definitions and functions of parameters in the process of registering a device in the domain.

TABLE 5
requestSubscribeDevice

| | |
|---|---|
| Parameter | DomainInfo domainInfo |
| description | Request for registering device in domain |

creatDeviceInfo

| | |
|---|---|
| Parameter | DomainInfo domainInfo |
| description | Register device in domain. If no error |
| | occurs, transmit true. If error occurs, |
| | transmit false. |

The requestSubscribeDevice is an interface for registering a device in a domain between the initiator 601 and the domain manager 603. The createDeviceInfo is an interface for the domain manager 603 to register a device in a domain. If no error occurs in the device registering process, the domain manager 603 transmits a true value to the initiator 601. If error occurs, the domain manager 603 transmits a false value to the initiator 601.

In a process for releasing the registration of a device from a domain, the initiator 601 requests the domain manager 603 to release the registration of a device from a domain by substituting the interface of the step S601 from requestNewDomain to requestUnsubscribeDevice. The domain manager 603 releases the registration of the device from the domain according to the request by substituting the interface of the step S609 from createDomainInfo to deleteDeviceInfo. Then, the domain manager 603 transmits the result of the device registration release to the initiator 601 at step S611 (return Message).

Table 6 shows the definitions and functions of a parameter in a process of releasing device registration from a domain.

TABLE 6
requestUnsubscribeDevice

| | |
|---|---|
| Parameter | DomainInfo domainInfo |
| description | Request for releasing device registration |
| | from domain |

deleteDeviceInfo

| | |
|---|---|
| Parameter | DomainInfo domainInfo |
| description | release device registration from domain. If |
| | no error occurs, transmit true. If error |
| | occurs, transmit false. |

The requestUnsubscribeDevice is an interface for releasing the registration of a device from a domain between the initiator 601 and the domain manager 603. The deleteDeviceInfo is an interface for the domain manager 603 to release the registration of a device from a domain. If no error occurs in the device registration release process, the domain manager 603 transmits a true value to the initiator 601. If error occurs in the device registration release process, the domain manager 603 transmits a false value to the initiator 601.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

While the present invention has been described with respect to certain preferred embodiments, it will be apparent to those skilled in the art that various changes and modifications may be made without departing from the spirits and scope of the invention as defined in the following claims.

### INDUSTRIAL APPLICABILITY

As described above, the apparatus and method for intellectual property management and protection (IPMP) according to an embodiment of the present invention enables IPMP tools to exchange information by confirming IPMP tools and manage a domain. Therefore, tools can interoperate with each other, and a predetermined domain is allowed to use protected contents.

What is claimed is:

1. An intellectual property management and protection (IPMP) apparatus using a tool (first tool) for managing and protecting intellectual property of contents and the other tool (second tool) interacting with the first tool, comprising:
a tool information extraction unit for extracting information of the second tool based on a request of the first tool; and
a tool reference unit for retrieving a location of the second tool based on the request of the first tool and the extracted information of the second tool.

2. The IPMP apparatus of claim 1, wherein the first tool communicates with the tool information extraction unit through a first IPMP interface for determining whether the second tool is present or not.

3. The IPMP apparatus of claim 2, wherein the first IPMP interface is defined as:
getToolContext

| | |
|---|---|
| Parameter | IPMPDescriptor ipmpInfo |
| description | search predetermined tool context ID |

4. The IPMP apparatus of claim 1, wherein the first tool communicates with the tool reference unit through a second IPMP interface for confirming a location of the second tool.

5. The IPMP apparatus of claim 4, wherein the second IPMP interface is an interface for the tool reference unit to search a reference of an IPMP tool group related to the second tool or a reference of a single IPMP tool not included in the IPMP tool group.

6. The IPMP apparatus of claim 5, wherein the second IPMP interface is defined as:
getToolGroupReference

| | |
|---|---|
| Parameter | UUID toolID |
| description | Search reference of IPMP tool group related |
| | to corresponding inputted toolID |

7. The IPMP apparatus of claim 5, wherein the second IPMP interface is defined as:
getToolReference

| | |
|---|---|
| Parameter | UUID toolID |
| description | search reference of a predetermined single |
| | IPMP tool not included in IPMP tool group |
| | according to inputted toolID |

8. The IPMP apparatus of claim 1, wherein the tool information extraction unit extracts the information of the second IPMP tool from a tool context including information about a tool ID, a substitutable tool, and a tool location.

9. The IPMP apparatus of claim 1, wherein the request of the first tool includes a tool ID of the second tool.

10. An intellectual property management and protection (IPMP) method using a first tool for managing and protecting intellectual property for contents and a second tool interacting with the first tool, comprising the steps of:
a) extraction information of the second tool based on a request of the first tool; and
b) retrieving a location of the second tool based on the request of the first tool and the extracted information of the second tool.

11. The IPMP method of claim 10, wherein in the step a), the information of the second tool is extracted through a first IPMP interface for confirming whether the second tool is present or not.

12. The IPMP method of claim 10, wherein the first IPMP interface is defined as:
getToolContext

| | |
|---|---|
| Parameter | IPMPDescriptor ipmpInfor |
| description | search predetermined tool context ID |

13. The IPMP method of claim 10, wherein in the step b), the location of the second tool is retrieved through a second IPMP interface for determining the location of the second tool.

14. The IPMP method of claim 13, wherein the second IPMP interface is an interface for searching a reference of an IPMP tool group related to the second tool and a reference of a single IPMP tool not included in the IPMP tool group.

15. The IPMP method of claim 14, wherein the second IPMP interface is defined as:
getToolGroupReference

| | |
|---|---|
| Parameter | UUID toolID |
| description | Search reference of IPMP tool group related |
| | to corresponding inputted toolID |

16. The IPMP method of claim 14, wherein the second IPMP interface is defined as:
getToolReference

| | |
|---|---|
| Parameter | UUID toolID |
| description | search reference of a predetermined single |
| | IPMP tool not included in IPMP tool group |
| | according to inputted toolID |

17. The IPMP method of claim 10, wherein in the step a), the information of the second IPMP tool is detected from tool context having information about a tool ID, a substitutable tool, and a tool location.

18. The IPMP method of claim 10, wherein the request of the first tool includes a tool ID of the second tool.

19. An intellectual property management and protection (IPMP) apparatus comprising:
an initiator for transmitting a domain management request including authentication information;
an authentication unit for performing an authentication process based on the authentication information transferred from the initiator; and
a domain manager for responding the domain management request based on the authentication result from the authentication unit,
wherein the domain is a set of devices that share same properties.

20. The IPMP apparatus of claim 19, wherein the domain management includes addition of a new domain.

21. The IPMP apparatus of clam 19, wherein the domain management includes deletion of a domain.

22. The IPMP apparatus of claim 19, wherein the domain management includes update of domain information.

23. The IPMP apparatus of claim 19, wherein the domain management includes registering a device for a domain.

24. The IPMP apparatus of claim 19, wherein the domain management includes releasing a device from a domain.

25. An intellectual property management and protection (IPMP) method, comprising the steps of:
a) transmitting a domain management request including authentication information;
b) performing an authentication process based on the authentication information transmitted at the step a); and
c) managing a domain by responding the domain management request based on the authentication result,
wherein the domain is a set of devices sharing same properties.

26. The IPMP method of claim 25, wherein the domain management includes addition of a new domain.

27. The IPMP method of claim 25, wherein the domain management includes deletion of a domain.

28. The IPMP method of claim 25, wherein the domain management includes update of domain information.

29. The IPMP method of claim 25, wherein the domain management includes registering a device for a domain.

30. The IPMP method of claim 25, wherein the domain management includes releasing a device from a domain.
